(19) United States
(12) Patent Application Publication
(10) Pub. No.: US 2020/0070882 A1
(43) Pub. Date: Mar. 5, 2020

(54) Intermediate Steering Shaft for a Motor Vehicle

(71) Applicant: Robert Bosch GmbH, Stuttgart (DE)

(72) Inventors: Mark Laszlo, Borsodnadasd (HU); Olivér Abonyi, Egerszalok (HU); Istvan Polacsek, Eger (HU)

(21) Appl. No.: 16/467,335

(22) PCT Filed: Nov. 22, 2017
(86) PCT No.: PCT/EP2017/080016

§ 371 Date: Jun. 6, 2019

(30) Foreign Application Priority Data
Dec. 8, 2016 (DE) 10 2016 123 742.6

(51) Int. Cl. B62D 7/16; F16C 3/035; F16C 29/04

(52) U.S. Cl. CPC B62D 7/166; F16C 2326/24; F16C 29/04; F16C 3/035

(57) ABSTRACT

An intermediate steering shaft for a motor vehicle includes a profile element inserted into a hollow profile shaft to form a circulating device. The profile element includes a second peripheral track segment associated, respectively, to a plurality of guide arrangements.

The invention relates to an intermediate steering shaft for a motor vehicle.

### PRIOR ART

Intermediate steering shafts are generally designed such that they can be lengthened and/or shortened. In this way, it is sought to achieve that relative movements that occur between a driver's cab and a vehicle chassis during driving operation of the motor vehicle do not have an adverse effect on the steering characteristics.

DE 25 38 686 discloses a bearing arrangement for axially displaceable parts which are couplable to one another in a direction of rotation, in particular telescopically guided articulated shafts, in the case of which the guidance and force transmission is realized by means of balls which can be caused to roll in an endless row in the inner and outer shaft parts, which balls are guided in circulation tracks which are axially parallel and situated radially opposite with respect to one another and which are dosed at both ends by means of arcuate diverting bends.

The arrangement for the guidance and force transmission by means of the balls which can be caused to roll in an endless row in the inner and outer shaft parts is however highly complex with regard to the number of installed components and the installation into the articulated shaft.

The invention is therefore based on the object of specifying an intermediate steering shaft for a motor vehicle which is inexpensive to produce and exhibits low complexity.

The object is achieved by means of an intermediate steering shaft for a motor vehicle having the features of patent claim 1.

### DISCLOSURE OF THE INVENTION

The present invention provides an intermediate steering shaft for a motor vehicle having an outer hollow shaft, having an inner hollow shaft which is arranged at least partially in the outer hollow shaft, having a hollow profiled shaft which is arranged in the outer hollow shaft and which is connected rotationally conjointly to the inner hollow shaft, having a multiplicity of guide arrangements which guide the hollow profiled shaft in an axial direction in the outer hollow shaft and which are designed to transmit a torque of the outer hollow shaft to the hollow profiled shaft, wherein the multiplicity of guide arrangements have guide means arranged in each case on an outer surface of the hollow profiled shaft and has a multiplicity of balls, and having a circulation device which is designed to guide the multiplicity of balls of each of the multiplicity of guide arrangements in an endless series in a dosed circulation track, wherein the dosed circulation track has in each case one first circulation track portion and one second circulation track portion, wherein the multiplicity of balls in the first circulation track portion are arranged between the guide means and an inner surface of the outer hollow shaft, characterized in that the circulation device is formed by a profiled element inserted into the hollow profiled shaft, which profiled element has the second circulation track portion assigned in each case to the multiplicity of guide arrangements.

It is a concept of the present invention to improve an intermediate steering shaft for a motor vehicle so as to reduce the complexity of the intermediate steering shaft through provision of the circulation device which can be inserted into the hollow profiled shaft.

Advantageous embodiments and refinements will emerge from the subclaims and from the description with reference to the figures.

According to a preferred refinement, it is provided that the second circulation track portion is formed in each case between a receiving portion of the circulation device and an inner surface of the hollow profiled shaft, and wherein the second circulation track portion is arranged substantially parallel to the first circulation track portion. It is thus possible for the multiplicity of balls to be easily extracted from the first circulation track portion and returned into the first circulation track portion by the second circulation track portion.

According to a further preferred refinement, it is provided that the hollow profiled shaft has, at axial end portions of the respective first circulation track portion, an opening which is formed in a radial direction and which connects the first circulation track portion to the second circulation track portion. It is thus advantageously possible for a closed circulation track to be provided by means of this simple design measure.

According to a further preferred refinement, it is provided that the multiplicity of balls of each of the guide arrangements have a multiplicity of balls of a first diameter and a multiplicity of balls of a second diameter which differs from the first diameter, wherein the first diameter is greater than the second diameter, and wherein the multiplicity of balls are arranged such that a ball of the first diameter and a ball of the second diameter are arranged in each case adjacent to one another. Owing to such a form and arrangement of the differently dimensioned balls, it is advantageously the case that, during operation of the intermediate steering shaft, if the latter is deflected, that is to say the outer hollow shaft is displaced relative to the profiled hollow shaft, only rolling friction and no sliding friction of the balls occurs, because the balls of relatively small diameter do not transmit any torque and can thus rotate counter to a running direction of the balls of the first diameter.

According to a further preferred refinement, it is provided that the balls of the first diameter are formed from steel, wherein the balls of the first diameter are designed to transmit the torque acting on the outer hollow shaft to the hollow profiled shaft, and wherein the balls of the second diameter are formed from steel or plastic, wherein the balls of the second diameter are spacers of the balls of the first diameter. A transmission of torque from the outer hollow shaft to the profiled hollow shaft thus takes place preferably only by means of the balls of the first diameter, whereas the balls of the second diameter serve as spacers, whereby sliding friction between the balls of the first diameter and the balls of the second diameter can advantageously be avoided, and thus only rolling friction occurs.

According to a further preferred refinement, it is provided that the balls of the first diameter make contact in each case with the guide means and the inner surface of the outer hollow shaft, and wherein the balls of the second diameter in each case exhibit radial play between the guide means and the inner surface of the outer hollow shaft. In this way, it is advantageously ensured that only the balls with the larger diameter transmit the torque from the outer hollow shaft to the profiled hollow shaft, whereas the balls with the smaller diameter can rotate counter to the direction of rotation of the larger balls owing to the radial play if the multiplicity of balls is in motion owing to a deflection of the intermediate steering shaft.

According to a further preferred refinement, it is provided that, at the axial end portions of the first and second circulation track portion, in each case one diverting element is inserted into the opening formed in the radial direction of the hollow profiled shaft, which diverting element is designed to divert the multiplicity of balls from the first circulation track portion into the second circulation track portion and vice versa. Owing to the easy insertability of the diverting element, it is preferably possible for a circulation device of simple construction to be provided.

According to a further preferred refinement, it is provided that the guide means have at least one guide rail and an elastic element formed as an O-ring, wherein the at least one guide rail is arranged at least in certain portions between the outer surface of the hollow profiled shaft and the multiplicity of balls, and wherein the outer surface of the hollow profiled shaft and the at least one guide rail have in each case one mutually adjacently arranged recess for receiving the elastic element, wherein the respective diverting elements hold the elastic element in position. The elastic element formed as an O-ring can thus be advantageously preloaded and held in position by means of the diverting elements.

According to a further preferred refinement, it is provided that the diverting elements are formed from plastic and have a PTFE coating. The multiplicity of balls can be diverted preferably with low friction from the first circulation track portion into the second circulation track portion and vice versa.

According to a further preferred refinement, it is provided that the circulation device and the diverting elements fix one another in the assembled state, wherein the circulation device fixes the diverting elements in the axial direction and in the radial direction, and wherein the diverting elements fix the circulation device in the axial direction. Owing to the easy insertability and mutual fixing of the circulation device and of the diverting elements, the multiplicity of balls can be guided preferably with structurally simple means in a closed circulation track.

According to a further preferred refinement, it is provided that the at least one guide rail has, at the respective axial end portions in the region of the opening, formed in the radial direction, of the hollow profiled shaft, a bevel such that a shape of the at least one guide rail is adapted to a circular shape, formed substantially in the radial direction of the hollow profiled shaft, of the opening of the hollow profiled shaft. It can thus advantageously be ensured that, at the axial end portions of the first and second circulation track portions, the respective balls do not become jammed with the hollow profiled shaft as they enter the opening inserted into the hollow profiled shaft, but can rather be guided in a flowing movement and with low friction along the closed circulation track.

According to a further preferred refinement, it is provided that the hollow profiled shaft has ribs formed in edge regions of the respective guide arrangement, and wherein the outer hollow shaft has at least one projection formed on the inner surface, which projection is designed to transmit the torque acting on the outer hollow shaft to the ribs of the hollow profiled shaft in the event of a failure of the respective guide arrangement. It is thus preferably possible for safe and reliable transmission of the torque from the outer hollow shaft to the hollow profiled shaft to be ensured even in the event of a failure of one of the respective guide arrangements.

The described embodiments and refinements may be combined with one another in any desired manner.

Further possible embodiments, refinements and implementations of the invention also encompass combinations, not explicitly mentioned, of features of the invention described above or described below with regard to the exemplary embodiments.

### BRIEF DESCRIPTION OF THE DRAWINGS

The appended drawings are intended to convey further understanding of the embodiments of the invention. They illustrate embodiments and serve, in conjunction with the description, for explaining principles and concepts of the invention.

Other embodiments, and several of the stated advantages, will emerge with regard to the drawings. The illustrated elements of the drawings are not necessarily shown to scale with respect to one another.

In the drawings:

FIG. 1 is a schematic illustration of an intermediate steering shaft for a motor vehicle as per a preferred embodiment of the invention;

FIG. 2 shows a longitudinal sectional view of a sub-portion, indicated in FIG. 1, of the intermediate steering shaft as per the preferred embodiment of the invention;

FIG. 3 shows a cross-sectional view, in the section plane B-B illustrated in FIG. 2, of the intermediate steering shaft for a motor vehicle as per the preferred embodiment of the invention;

FIG. 4 shows a cross-sectional view, in the section plane C-C illustrated in FIG. 2, of the intermediate steering shaft for a motor vehicle as per the preferred embodiment of the invention;

FIG. 5 is a schematic illustration of a circulation device of the intermediate steering shaft for a motor vehicle as per the preferred embodiment of the invention;

FIG. 6 shows a longitudinal sectional view of a sub-portion of the intermediate steering shaft as per the preferred embodiment of the invention;

FIG. 7 shows a side view of a guide rail of the intermediate steering shaft as per the preferred embodiment of the invention;

FIG. 8 is a schematic illustration of the guide rail of the intermediate steering shaft as per the preferred embodiment of the invention;

FIG. 9 is a schematic illustration of the intermediate steering shaft having a guide arrangement as per the preferred embodiment of the invention; and

FIG. 10 is a schematic illustration of a diverting element of the intermediate steering shaft as per the preferred embodiment of the invention.

In the figures, the same reference designations are used to denote identical or functionally identical elements, parts or components, unless stated otherwise.

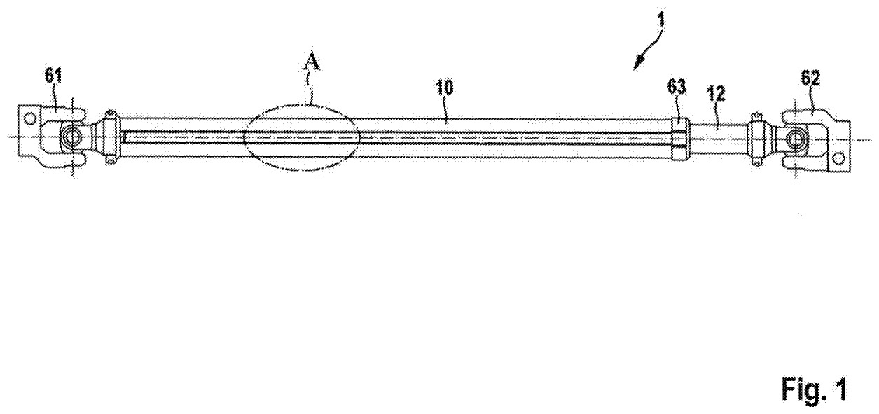

FIG. 1 is a schematic illustration of an intermediate steering shaft for a motor vehicle as per a preferred embodiment of the invention.

The intermediate steering shaft 1 for a motor vehicle has an outer hollow shaft 10, an inner hollow shaft 12 and a profiled shaft (not shown in FIG. 1) which connects the outer hollow shaft 10 and the inner hollow shaft 12 to one another. The intermediate steering shaft 1 is connected at a first end to a first ball joint 61 and at a second end to a second ball joint 62. The intermediate steering shaft 1 can be telescopically lengthened and shortened proceeding from an initial position in order to compensate relative movements that occur between a driver's cab and a chassis during driving operation of the motor vehicle, such that said relative movements do not have an adverse effect on the steering characteristics of the vehicle. The intermediate steering shaft 1 furthermore has, on an end of the outer hollow shaft 10 at which the inner hollow shaft 12 emerges from the outer hollow shaft 10, a stripper 63 which preferably has a seal.

Thus, in the event of a rotation of the outer hollow shaft 10 effected by means of a rotational movement of a steering column of the motor vehicle, the torque is transmitted to the inner hollow shaft 12 and from the latter to a steering gear of the motor vehicle.

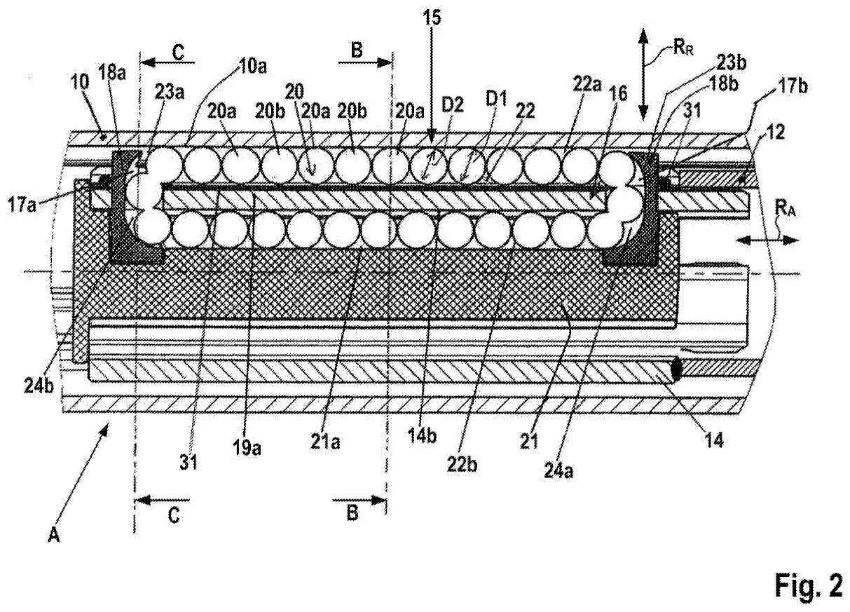

FIG. 2 shows a longitudinal sectional view through a sub-portion, indicated in FIG. 1, of the intermediate steering shaft as per the preferred embodiment of the invention.

The intermediate steering shaft 1 is shown in FIG. 2 in the assembled state. Here, a hollow profiled shaft 14 has been inserted into the outer hollow shaft 10, which hollow profiled shaft is connected to an inner hollow shaft 12. The connection between the hollow profiled shaft 14 and the inner hollow shaft 12 is preferably a welded connection.

The hollow profiled shaft 14 is connected rotationally conjointly to the inner hollow shaft 12. The intermediate steering shaft 1 furthermore has a multiplicity of guide arrangements 15 which guide the hollow profiled shaft 14 in an axial direction R_{A} in the outer hollow shaft 10. The guide arrangements 15 are designed to transmit a torque of the outer hollow shaft 10 to the hollow profiled shaft 14. The multiplicity of guide arrangements 15 has guide means 16 arranged in each case at an outer surface 14a of the hollow profiled shaft 14, and a multiplicity of balls 20.

The intermediate steering shaft 1 furthermore has a circulation device 21. The circulation device 21 is designed to guide the multiplicity of balls 20 of each of the multiplicity of guide arrangements 15 in an endless row in a closed circulation track 22, wherein the dosed circulation track 22 has in each case one first circulation track portion 22a and one second circulation track portion 22b. The multiplicity of balls 20 are, in the first circulation track portion 22a, arranged between the guide means 16 and an inner surface 10a of the outer hollow shaft 10. The circulation device 21 is formed by a profiled element inserted into the hollow profiled shaft 14. The profiled element has the second circulation track portion 22b assigned in each case to the multiplicity of guide arrangements 15.

The second circulation track portion 22b is formed preferably in each case between a receiving portion 21a of the circulation device 21 and an inner surface 14b of the hollow profiled shaft 14. The second circulation track portion 22b is arranged preferably substantially parallel with respect to the first circulation track portion 22a.

The hollow profiled shaft 14 preferably has, at axial end portions 23a, 23b of the respective first circulation track portion 22a, an opening 17a, 17b formed in a radial direction R_{R}. The opening 17a, 17b preferably connects the first circulation track portion 22a to the second circulation track portion 22b.

The multiplicity of balls 20 of each of the guide arrangements 15 has a multiplicity of balls of a first diameter D1 and a multiplicity of balls of a second diameter D2, which differs from the first diameter D1. The first diameter D1 is preferably greater than the second diameter D2. The multiplicity of balls 20 is preferably arranged such that a ball 20a of the first diameter D1 and a ball 20b of the second diameter D2 are arranged in each case adjacent to one another.

At the axial end portions 23a, 23b of the first and second circulation track portions 22a, 22b, in each case one diverting element 18a, 18b is inserted into the opening 17a, 17b formed in the radial direction R_{R} of the hollow profiled shaft 14. The diverting element 18a, 18b is preferably designed to divert the multiplicity of balls 20 from the first circulation track portion 22a into the second circulation track portion 22b and vice versa.

The diverting elements 18a, 18b are preferably formed from plastic and have a PTFE coating. Alternatively, the diverting elements 18a, 18b may for example also be formed from some other suitable material or have some other suitable coating.

The circulation device 21 and the diverting elements 18a, 18b preferably fix one another in the assembled state. Here, the circulation device 21 fixes the diverting elements 18a, 18b preferably in the axial direction R_{A} and in the radial direction R_{R}. The diverting elements 18a, 18b fix the circulation device 21 preferably in the axial direction R_{A}. Alternatively, some other type of mutual fixing of the circulation device 21 and of the diverting elements 18a, 18b is conceivable.

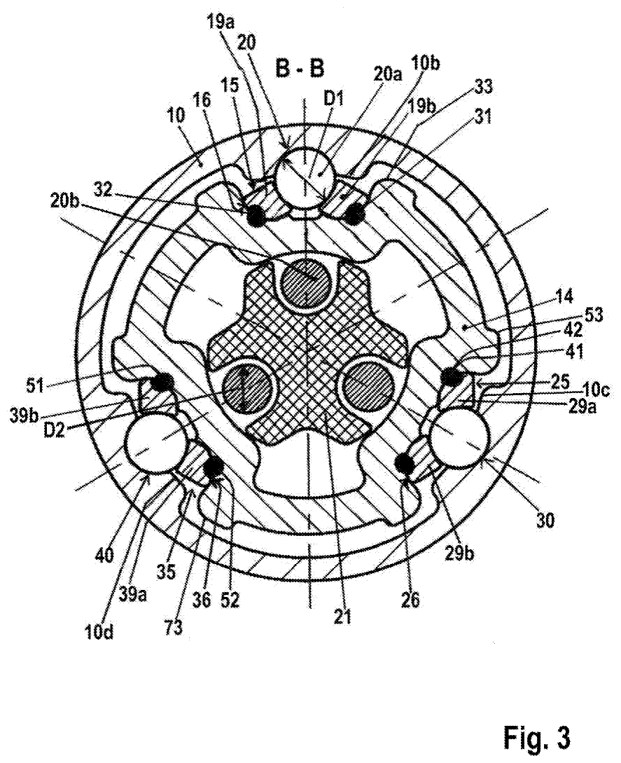

FIG. 3 shows a cross-sectional view of the section plane B-B, illustrated in FIG. 2, of the intermediate steering shaft for a motor vehicle as per the preferred embodiment of the invention.

The balls 20a, 30a, 40a of the first diameter D1 are preferably formed from steel. The balls 20a, 30a, 40a of the first diameter D1 are preferably designed to transmit torque acting on the outer hollow shaft 10 to the hollow profiled shaft 14. The balls 20b, 30b, 40b of the second diameter D2 are preferably formed from steel. Alternatively, the balls 20b, 30b, 40b of the second diameter D2 may for example be formed from plastic. The balls 20b, 30b. 40b of the second diameter D2 are preferably spacers of the balls 20a, 30a, 40a of the first diameter D1.

The balls 20a, 30a, 40a of the first diameter D1 make contact in each case with the guide means 16, 26, 36 and with the inner surface 10a of the outer hollow shaft 10. The balls 20b, 30b, 40b of the second diameter D2 preferably exhibit radial play in each case between the guide means 16, 26, 36 and the inner surface 10a of the outer hollow shaft 10.

The guide means 16, 26, 36 have at least one guide rail 19a, 19b, 29a. 29b, 39a, 39b and an elastic element 31, 41, 51 in the form of an O-ring. The at least one guide rail 19a, 19b, 29a, 29b, 39a, 39b is arranged in certain portions between the outer surface 14a of the hollow profiled shaft 14 and the multiplicity of balls 20, 30, 40. The outer surface 14a of the hollow profiled shaft 14 and the at least one guide rail 19a, 19b, 29a, 29b, 39a, 39b have in each case one mutually adjacently arranged recess 32, 42, 52 for receiving the elastic element 31, 41, 51. Here, the respective diverting elements 18a, 28a, 38a hold the elastic element 31, 41, 51 in position. Alternatively, some other suitable arrangement is for example conceivable.

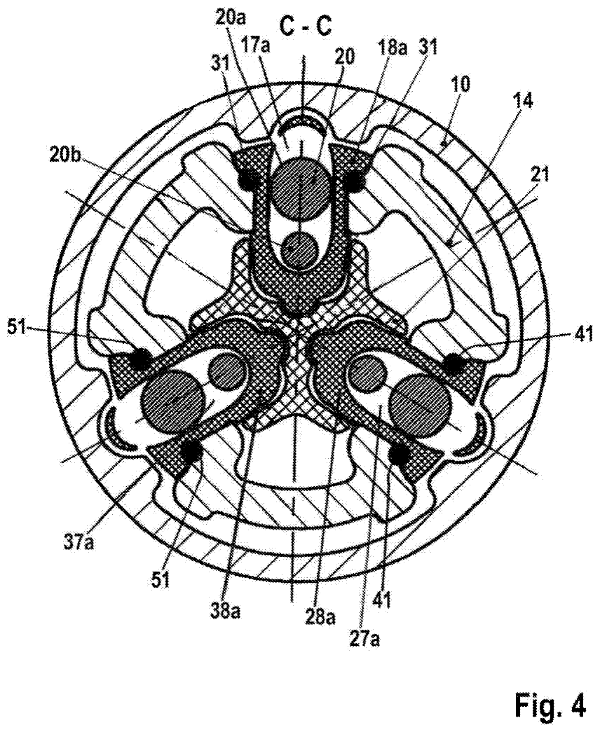

FIG. 4 shows a cross-sectional view of the section plane C-C illustrated in FIG. 2 of the intermediate steering shaft for a motor vehicle as per the preferred embodiment of the invention.

In FIG. 4, it is possible to dearly see a difference in dimensions between the balls 20a of the first diameter and the balls 20b of the second diameter. The balls 20b of the second diameter in this case preferably exhibit radial play between respective wall surfaces of the diverting element 18a, 28a, 38a. Likewise preferably illustrated is the relatively small dimensioning (in relation to conventional devices of this type) of the circulation device 21 which is inserted into the hollow profiled shaft 14. This furthermore results in a weight saving. The respective diverting elements 18a, 28a, 38a, which are inserted into the corresponding openings 17a, 27a, 37a of the hollow profiled shaft, furthermore advantageously have, on a respective outer wall, wedge-shaped elements (not illustrated in FIG. 4) which, after the insertion of the diverting elements 18a, 28a, 38a into the openings 17a, 27a, 37a, effect a detent engagement of the diverting elements into the openings, such that said diverting elements are securely arrested in the openings 17a, 27a, 37a.

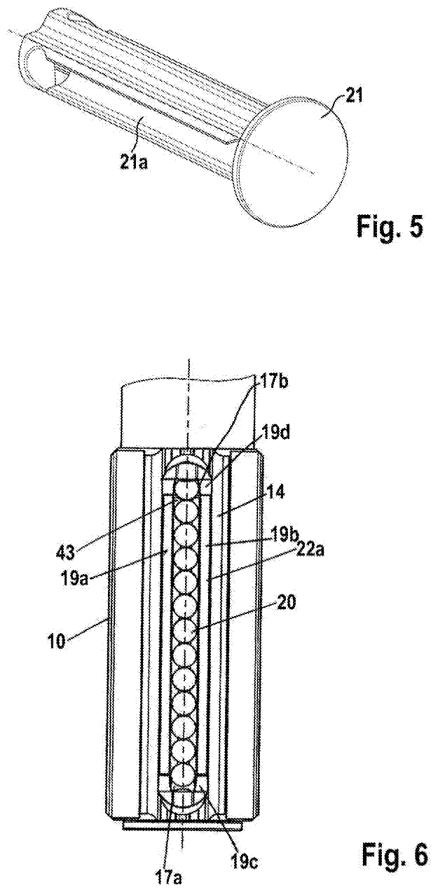

FIG. 5 is a schematic illustration of a circulation device of the intermediate steering shaft for a motor vehicle as per the preferred embodiment of the invention. The circulation device 21 preferably has a multiplicity of, in the present exemplary embodiment three, receiving portions 21a which are designed to, in the inserted state of the circulation device, receive the profiled hollow shaft (not shown in FIG. 5) in each case the multiplicity of balls in order to guide these in the dosed circulation track (not shown in FIG. 5).

FIG. 6 shows a longitudinal sectional view of a sub-portion of the intermediate steering shaft as per the preferred embodiment of the invention. The multiplicity of balls 20 are preferably guided in the first circulation track portion 22a. Respective axial end portions 19c, 19d of the guide rail 19a preferably have a bevel 43 which makes it possible for the multiplicity of balls 20 to more easily protrude into, or be guided in, the openings 17a. 17b of circular form of the hollow profiled shaft 14.

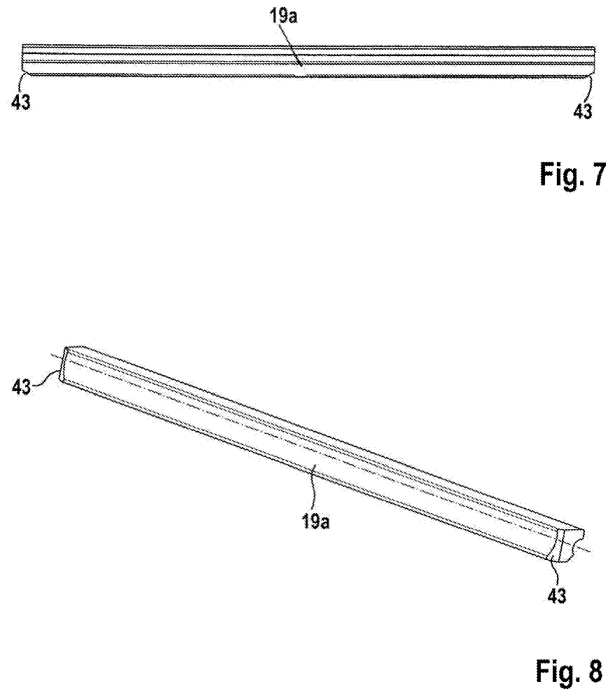

FIG. 7 shows a side view of a guide rail of the intermediate steering shaft as per the preferred embodiment of the invention. The guide rail 19a preferably has the bevel 43 in the illustrated region. The bevel 43 is preferably designed to form, in the assembled state of the guide rail, a shape such that the multiplicity of balls (not shown in FIG. 7) to guide into the opening of the hollow profiled shaft, which is of circular form in the radial direction of the hollow profiled shaft, without becoming jammed with the guide rail 19a.

FIG. 8 is a schematic illustration of the guide rail of the intermediate steering shaft as per the preferred embodiment of the invention. The illustration shown in FIG. 8 shows a three-dimensional form of the bevel 43 of the guide rail 19a. In this way, the guide rail 19a can advantageously adapt to the circular shape of the opening (not illustrated in FIG. 8) of the hollow profiled shaft.

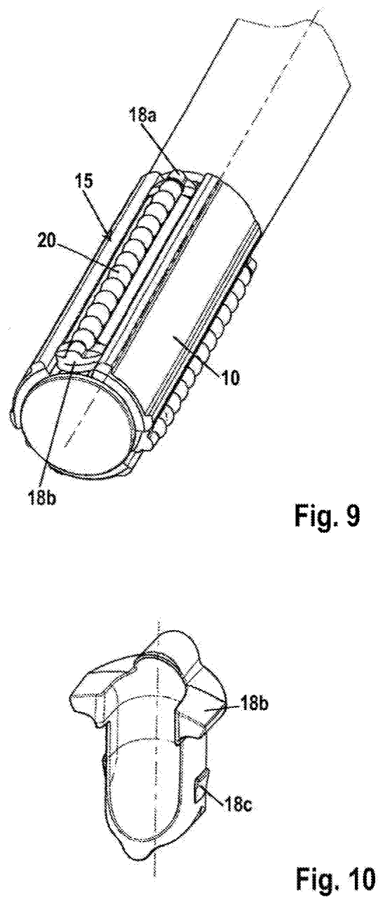

FIG. 9 is a schematic illustration of the intermediate steering shaft having a guide arrangement as per the preferred embodiment of the invention. The diverting elements 18a, 18b are inserted into the openings (not illustrated in FIG. 9) of the hollow profiled shaft 14 such that these protrude in certain portions out of the openings. The diverting elements 18a, 18b thus advantageously form axial delimitations for the multiplicity of balls, such that said balls cannot move beyond the defined delimitation in the axial direction.

FIG. 10 is a schematic illustration of a diverting element of the intermediate steering shaft as per the preferred embodiment of the invention. The illustrated diverting element 18b preferably has the wedge-shaped element 18c on an outer wall. The wedge-shaped element 18c is preferably arranged severalfold around the outer wall of the diverting element 18b and serves, during the insertion of the diverting element 18b into the opening (not illustrated in FIG. 10) of the hollow profiled shaft, as a detent lug for the secure arresting of the diverting element 18b in the opening of the hollow profiled shaft.

Even though the present invention has been described above on the basis of preferred exemplary embodiments, it is not restricted to these and may be modified in a variety of ways. In particular, the invention may be changed or modified in numerous ways without departing from the essence of the invention.

For example, a shape, dimensioning or machining or production method of the components of the intermediate steering shaft may be modified.

### LIST OF REFERENCE DESIGNATIONS

1 Intermediate steering shaft
10 Outer hollow shaft
10a Inner surface of the outer hollow shaft
10b, 10c, 10d Projection
12 Inner hollow shaft
14 Profiled hollow shaft
14a Outer surface of the hollow profiled shaft
14b Inner surface of the hollow profiled shaft
15, 25, 35 Guide arrangements
15a, 15b, 25a, 25b, 35a, 35b Edge regions of the guide arrangements
16, 26, 36 Guide means
17a, 17b, 27a, 37a Opening
18a, 18b, 28a, 38a Diverting element
18c Wedge-shaped element
19a, 19b, 29a, 29b, 39a, 39b Guide rail
20, 30, 40 Balls
20a, 30a, 40a Balls of a first diameter
20b, 30b, 40b Balls of a second diameter
21 Circulation device
21a Receiving portion of the circulation device
22 Circulation track
22a First circulation track portion
22b Second circulation track portion
23a, 23b Axial end portions
24a, 24b Axial end portions
31, 41, 51 Elastic element
32, 42, 52 Recess
33, 53, 73 Ribs
43 Bevel
61, 62 Ball joint
63 Stripper
D1 First diameter
D2 Second diameter
R_{A} Axial direction
R_{R} Radial direction

1. An intermediate steering shaft for a motor vehicle the intermediate steering shaft comprising:
an outer hollow shaft including an inner surface;
an inner hollow shaft positioned at least partially in the outer hollow shaft;
a hollow profiled shaft positioned in the outer hollow shaft and connected rotationally conjointly to the inner hollow shaft;
a plurality of guide arrangements configured to (i) guide the hollow profiled shaft in an axial direction in the outer hollow shaft and (ii) transmit a torque of the outer hollow shaft to the hollow profiled shaft, each of the plurality of guide arrangements including:
a respective guide mechanism positioned on an outer surface of the hollow profiled shaft; and
a respective plurality of balls; and
a profile element inserted into the hollow profiled shaft so as to form a circulation device, wherein:
the circulation device includes a closed circulation track, and is configured to guide the multiplicity respective plurality of balls of each of the plurality of guide arrangements in an endless series in the closed circulation track
the closed circulation track has: a respective first circulation track portion assigned to each guide arrangement, the respective first circulation track portion arranged such that the respective plurality of balls, when in the respective first circulation track portion, is located between the respective guide mechanism and the inner surface of the outer hollow shaft; and
the profiled element includes a respective second circulation track portion of the closed circulation track that is assigned to each guide arrangement.

2. The intermediate steering shaft as claimed in claim 1, wherein:
the circulation device further includes a receiving portion;
the respective second circulation track portion is arranged between the receiving portion of the circulation device and an inner surface of the hollow profiled shaft; and
the respective second circulation track portion is arranged substantially parallel to the respective first circulation track portion.

3. The intermediate steering shaft as claimed in claim 1, wherein the hollow profiled shaft includes, at each axial end portion of the respective first circulation track portion, a respective opening in a radial direction, the respective opening connecting the respective first circulation track portion to the respective second circulation track portion.

4. The intermediate steering shaft as claimed in claim 1, wherein:
the respective plurality of balls of each of the guide arrangements includes:
a first plurality of balls having a first diameter; and
a second plurality of balls having a second diameter that is smaller than the first diameter; and
the respective plurality of balls are arranged such that, in each case, a respective ball of the first diameter and a respective ball of the second diameter are adjacent to each other.

5. The intermediate steering shaft as claimed in claim 4, wherein:
the first plurality of balls are formed from steel, and are configured to transmit the torque acting on the outer hollow shaft to the hollow profiled shaft; and
the second plurality of balls are formed from steel or plastic, and are configured as spacers of the first plurality of balls.

6. The intermediate steering shaft as claimed in claim 5, wherein:
the first diameter is configured such that the first plurality of balls are configured to make contact with the respective guide mechanism and the inner surface of the outer hollow shaft; and
the second diameter is configured such that the second plurality of balls exhibit radial play between the respective guide mechanism and the inner surface of the outer hollow shaft.

7. The intermediate steering shaft as claimed in claim 3, further comprising:
a respective diverting element inserted into the respective opening at each axial end portion of the respective first and second circulation track portions, the diverting element configured to divert the respective plurality of balls from the respective first circulation track portion into the respective second circulation track portion and vice versa.

8. The intermediate steering shaft as claimed in claim 7, wherein:
the respective guide mechanism has:
at least one guide rail positioned, at least in portions, between the outer surface of the hollow profiled shaft and the respective plurality of balls; and
an elastic element formed as an O-ring;
the outer surface of the hollow profiled shaft and the at least one guide rail have, in each case, a respective mutually adjacently arranged recess configured to receive the elastic element; and
the respective diverting elements are configured to hold the elastic element in position.

9. The intermediate steering shaft as claimed in claim 7, wherein the respective diverting elements are formed from plastic, and include a coating formed from PTFE.

10. The intermediate steering shaft as claimed in claim 7, wherein:
the circulation device and the respective diverting elements fix each other in position, in an assembled state;
the circulation device fixes the respective diverting elements in the axial direction and in the radial direction; and
the respective diverting elements fix the circulation device in the axial direction.

11. The intermediate steering shaft as claimed in claim 8, wherein the at least one guide rail has, at respective axial end portions in a region of the respective openings, a bevel such that a shape of the at least one guide rail is adapted to a circular shape, and is formed substantially in the radial direction.

12. The intermediate steering shaft as claimed in claim 1, wherein:
the hollow profiled shaft ribs located in respective edge regions of the respective guide arrangement; and
the outer hollow shaft further includes at least one projection formed on the inner surface, the projection configured to transmit the torque acting on the outer hollow shaft to the ribs of the hollow profiled shaft in response to a failure of the respective guide arrangement.
